(19) United States
(12) Patent Application Publication
(10) Pub. No.: US 2004/0052468 A1
(43) Pub. Date: Mar. 18, 2004

(54) Alignable electro-optical microelectronic package and method

(76) Inventors: Cuong Van Pham, San Diego, CA (US); Frank J. Polese, San Diego, CA (US)

Correspondence Address: CHARMASSON & BUCHACA, 1545 HOTEL CIRCLE SOUTH, SUITE 150, SAN DIEGO, CA, 92108-3412, US

(21) Appl. No.: 10/406,786

(22) Filed: Apr. 2, 2003

Related U.S. Application Data
(60) Provisional application No. 60/369,592, filed on Apr. 2, 2002.
(60) Provisional application No. 60/407,470, filed on Aug. 29, 2002.

(51) Int. Cl. G02B 6/42

(52) U.S. Cl. 385/52; 385/91

(57) ABSTRACT

An opto-electronic semiconductor microcircuit chip package where the chip is mounted upon a substrate or boat which in turn is mounted to the floor of the package upon a pool of reflowable solder. Actuator wires connect from package pads to pads on the boat. When the solder is liquefied, the entire package is placed in a magnetic field and current runs through actuator wires in order to force rotation of the boat according to Maxwell's equations for electric current in a magnetic field. The current is adjusted to obtain the proper torque on the boat to move it into alignment with an impinging fiber optic cable. Once in alignment, the solder is cooled to lock the boat in place and in alignment.

### PRIOR APPLICATION

This application claims the benefit of U.S. Provisional Utility Patent Application Serial No. 60/369,592 filed Apr. 2, 2002, and Serial No. 60/407,470 filed Aug. 29, 2002.

### FIELD OF THE INVENTION

The invention relates to microphotonic packaging and more particularly to optical alignment between an optical conduit and an electro-optical microcircuit chip in.

### BACKGROUND OF THE INVENTION

Data transmission using optical media is enjoying rapid growth due to its ability to handle large amounts of data using relatively non-bulky and inexpensive transmission media such as fiber optic cable. Currently however, such optical data transmission requires the back-and-forth conversion of optical signals to electronic signals using electro-optical microelectronic converter devices. As shown in FIG. 1, such microcircuit converters are typically created on an integrated circuit chip 1 which has a wave-guide 2 for carrying an optical signal, shown as a light ray 3 to and from the end 4 of a fiber-optic cable 5. The wave-guide typically terminates at an interface end 6 facing the cable end, and an opposite end inside the chip at a photo-electronic convertor 7 which converts received optical signals to electronic impulses which are then processed by the chip. The converter also converts electronic signals into optical signals to be transmitted to the cable.

For the purpose of clarity, the remainder of this specification will generally refer to an optical signal arriving at the chip from an interfacing optical cable. Those skilled in the art will readily appreciate the application of the description in terms of optical signals emanating from the chip.

As shown in FIG. 2, because of the need for high reliability in telecommunication systems and because the microelectronic die or chip is relatively fragile compared to its supporting circuitry, it is usually encased in a package 10 to protect it from the outside environment. This package must allow communication with the die electrically through leads 11 penetrating the package, thermally and in the present application, optically through a fiber optic cable connection 12. These requirements have caused microcircuit packaging to become a complex science employing complex structures and manufacturing methods.

As shown in FIG. 3, in order to obtain maximum transmission of data, it is important that the interface 15 between the end 4 of the fiber optic cable 5 and the interface end 6 of the waveguide 2 be properly aligned. Errors in an alignment can lead to transmission loss and signal degradation across the interface. Alignment errors can be typically be characterized as an error in angle of incidence 16 of a signal carrying light ray 17 and its preferred or aligned direction 18. Typically, the preferred or aligned direction is perpendicular to the surface of the interface end 6 of the waveguide 2. Those skilled in the art will readily perceive that the error angle shown in FIG. 3 has been grossly emphasized for illustrative purposes.

Referring now to FIG. 4, it is well known that force F generated on a length L of straight wire in a uniform magnetic field B is proportional to the current i through the wire, the length of the wire, and the strength of the magnetic field according to Maxwell's equations 19. The force direction is normal to the plane formed by the field and the current direction.

It is therefore desirable to provide an opto-electronic microcircuit package which provides for enhanced alignment.

### SUMMARY OF THE INVENTION

The principal and secondary objects of this invention are to provide an opto-electronic microcircuit package which allows for inexpensively enhancing the alignment between an optical cable and an opto-electronic microcircuit chip.

These and other objects are fulfilled by an opto-electronic microcircuit package in which the microcircuit chip is mounted upon a substrate or boat which in turn is mounted within the cavity of the package upon a pool of reflowable solder. Larger chips can have backside metallization and be mounted directly upon the pool. Actuator wires connect from package pads to pads on the boat. When the solder is liquefied, the entire package is placed in a magnetic field and current runs through actuator wires in order to force rotation of the boat according to Maxwell's equations for electric current in a magnetic field. The current is adjusted to obtain the proper moment on the boat to move it into alignment with an impinging optical cable. Once in alignment, the solder is cooled to lock the boat in place and in alignment.

### BRIEF DESCRIPTION OF THE DRAWING

FIG. 1 is a prior art diagrammatic plan view of an optical cable interfacing with a portion of an opto-electronic microcircuit chip.

FIG. 2 is a prior art diagrammatic perspective view of an opto-electronic microcircuit package.

FIG. 3 is a prior art exaggerated diagrammatic view showing the angle of incidence of a light ray at an optical interface of an opto-electronic microcircuit chip.

FIG. 4 is a diagrammatic illustration of Maxwell's equations for electric current through a wire in a magnetic field.

FIG. 5 is a partial diagrammatic perspective view of an opto-electronic microcircuit metal package according to the invention.

FIG. 6 is a partial diagrammatic perspective view of an opto-electronic microcircuit ceramic package according to the invention.

FIG. 7 is a partial diagrammatic perspective view of a large scale opto-electronic microcircuit chip mounted directly within a ceramic package according to the invention.

FIG. 8 is a partial diagrammatic cross-sectional side view of the package of FIG. 5.

FIG. 9 is a partial diagrammatic perspective operational view of the package of FIG. 5, during the alignment process.

FIG. 10 is a flow chart diagram of the preferred method of aligning the optical interface of an opto-electronic microcircuit chip according to the invention.

FIG. 11 is a functional block diagram of a system for implementing the method of aligning the optical interface of an opto-electronic microcircuit chip according to the invention.

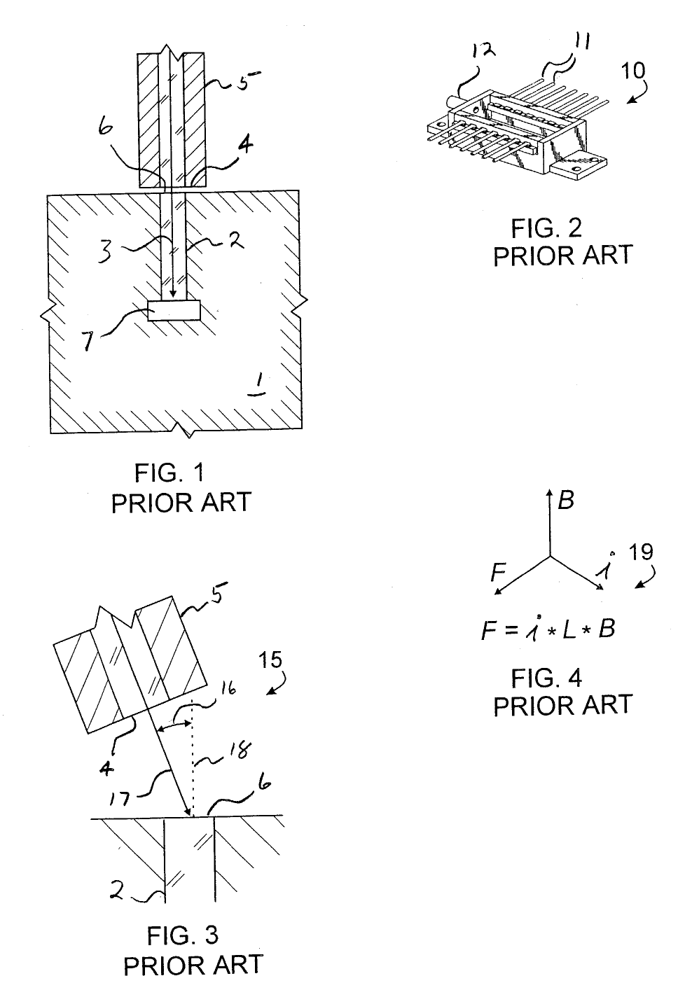

### DESCRIPTION OF THE PREFERRED EMBODIMENT OF THE INVENTION

The preferred embodiment is described in terms of a butterfly-type opto-electronic microcircuit package. However, those skilled in the art will readily appreciate the application of the invention to other opto-electronic packages and to other areas where alignment of a microcircuit chip within a package after die attach is required.

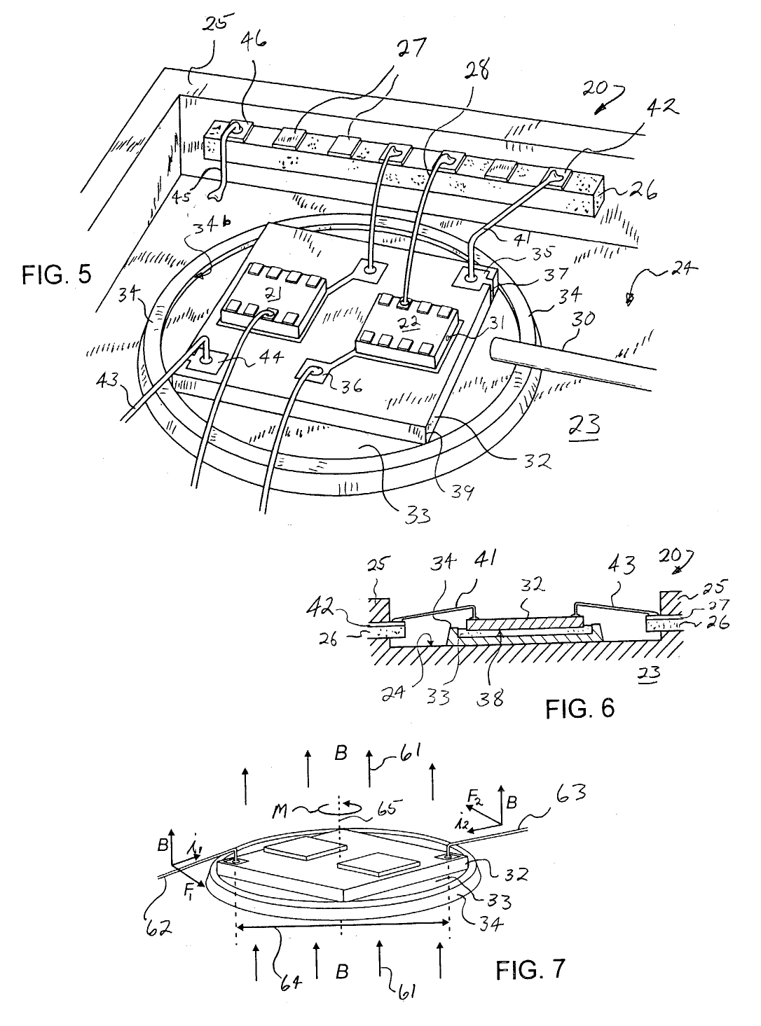

Referring now to the drawing, there is shown in FIGS. 5-7, a portion 20 of an opto-electronic microcircuit package for packaging a pair of electronic microcircuit chips 21,22. The first chip 21 is a logic or power chip which does not require special alignment. The second chip 22 is an opto-electronic chip which does require precise alignment with a fiber-optic cable 30. The package has a base or floor portion 23 which is preferably a heat dissipating copper-tungsten base having a substantially planar gold plated upper surface 24 bounded along two opposite peripheral edges by wall portions 25 which form a portion of the package housing. Each of the wall portions is slotted to allow insertion of a ceramic feed-through 26 which carries a plurality of electrical interconnection wire bonding pads 27 which are electrically connected to leads extending from the outer surface of the package. Some of the pads are in electrical communication with the opto-electronic microcircuit chip 22 through wire bond interconnects 28. The package encapsulates the opto-electronic die and supports a fiber-optic cable 30 which is in communication with the die 22 at an interface 31.

The dies are mounted upon a substantially quadrangular substrate or boat 32 which in turn, rests upon a pool 33 of reflowable material such as solder which is held in place by a substantially circular retaining wall 34 of a tank structure.

The boat 32 is preferably made of a metallizable material such as silicon, ceramic, aluminum nitrite, diamond, beryllium oxide or BT resin material. As described below, the boat is metallized to form electrical bonding pads 35,36, traces and to form edge electrical connection 37 to the solder pool. The undersurface of the boat can be fully metallized to form good electrical contact to the pool, and the boat may carry internal electrical vias between the pads and the undersurface.

Most preferably, the boat has a substantially square undersurface 38 so that its movement is restricted to rotational movement in the pool while translational movement is inhibited. In this way, the corners 39 of the boat are in close contact or held by surface tension close to the substantially circular inner surface 34b of the retaining wall 34 of the tank.

The type of solder used in the pool 33 of reflowable material is selected according to its compatibility with the materials used to form adjacent structures in the package. Clearly, the solder should have a melting temperature which is below the temperature which may affect other structures in the package such as any solder joint between the chips and the boat. Possible candidates include Tin-Lead, Tin-Silver, and Tin-Silver-Copper type solders. Solder alloys having a high thermal conductivity and sharp eutectic point such as eutectic Tin-Lead, and Tin-Silver-Copper and low latent heat characteristics are preferred so that rapid onset of complete liquification is achieved and subsequently, rapid solidification when heat is removed.

As described above, the solder pool 33 is held in place in a substantially circularly walled tank 34 formed by a ring of non-reflowable material such as higher temperature withstanding epoxy, or more preferably electrically conductive solder having a higher melting point than the solder pool. This allows for simpler electrical interconnection with the solder pool.

The tank and pool structures are generally formed onto the package floor using thick film screen printing techniques well known in the art. Alternately, the tank could be machined into the floor of the metal package cavity.

An electrically conductive actuator wire 41 extends from a wedge bond on one of the package pads 42 to a corner pad 35 on the boat 32 carrying the microcircuit chip 22. A similar wire 43 extends from a pad on the opposite side feed-through to a pad 44 on the diagonally opposite corner of the boat. The actuator wires are selected from a material and have a diameter which is electrically conductive enough to carry an amount of current which will result in an adequate amount of force to generate enough moment on the boat to adjust alignment. Preferably, the material has high elasticity to allow for minor bending and stretching to accommodate movement of the boat, and has high tensile strength to adequately impart the necessary mechanical force. Preferred materials are therefore gold, silver, aluminum, copper, nickel and related alloys. If gold is used, a thickness of between about 0.002 and 0.003 inch has been found to be adequate. In this way, die interconnect wire bonding an actuator wire bonding is performed in the same operation preferably using a ball/wedge-type bond configuration.

Each of the actuator wire bond pads 35,44 on the boat have an edge trace connector 37 which extends down the side of the boat and electrically interconnects with the underside metalization of the boat which contacts the solder pool 33 which itself is electrically conductive and interconnects with the conductive tank 34 which, in turn, is electrically connected to the gold plated upper surface 24 of the package cavity floor. A drain line 45 electrically connects the floor to a drain pad 46 on a feed-through 26 of the package.

Referring now to FIG. 7, the package is placed within a substantially uniform magnetic field indicated by upward flow lines 61, and the solder pool 33 is heated to a degree in which it becomes liquid, thereby allowing the chip carrying boat 32 to be movable upon it through application of minor forces. A current i₁,i₂ is applied to the actuator wires 62,63 of the boat and drained through the solder pool 33 and out through the drain wires. This generates forces F₁,F₂ on the actuator wires proportional to the current, the length of the wires and the strength of the magnetic field according to Maxwell's equations. Because the current i₁ entering the first actuator wire 62 is oriented directly opposite in direction the current i₂ entering the second actuator wire 63, the forces F₁,F₂ generated have an opposite direction. Since the wires are spaced apart by the distance 64 between the diagonal corners of the boat, the forces act in concert to create a moment M about the perpendicular axis 65 formed between the forces. This moment causes the boat to rotate. This movement, in turn, causes the die to move angularly with respect to the optical cable and thereby correct for angular error at the interface.

Referring now to FIG. 9, there is shown an alternate embodiment of the invention implemented in a ceramic package 90 wherein an opto-electronic chip 91 itself forms the boat mounted upon the reflowable solder pool 92. As with the previous embodiment, the package floor has metallization printed upon it to form a circular containment pad or tank 93 and drain pads 94. Wire bonds 95 connect the chip to the drain pads. The size of the preform is selected so that it remains contained upon the containment pad and automatically centers the chip/boat due to surface tension when the solder is molten. Bonded actuator wires 96,97 are used to move the chip/boat and aperture 98 into better alignment with a fiber-optic light source 99.

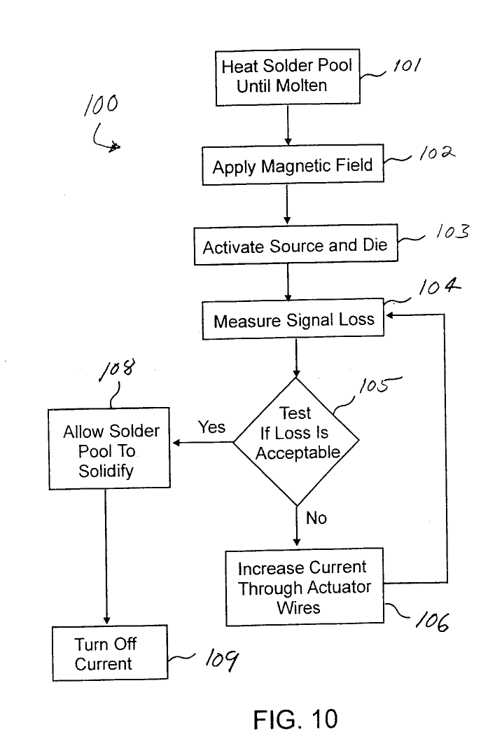

Referring now to FIG. 10, there is shown the preferred method 100 for aligning the opto-electronic die to an impinging optical cable. First, the solder pool is heated 101 until molten and a magnetic field is applied 102. Further, the operation of the die and source optical cable are activated 103 so that a signal may be measured which has passed through an interface between the cable and die. No particular order of the above steps is as yet preferred.

Once the above steps are taken, the signal is then measured 104 for its loss to see if its within an acceptable loss range and upon the results of this test 105, the actions are taken. If the loss is not acceptable, current is increased 106 through the actuator wires and a subsequent measurement taken 104. This feedback loop continues until the test reveals an acceptable loss, whereupon the solder pool is allowed to cool and solidify 108, at which point the current is turned off 109.

Of course, those skilled in the art will readily appreciate that care must be taken that the above-method does not exceed certain parameter ranges such as a maximum current.

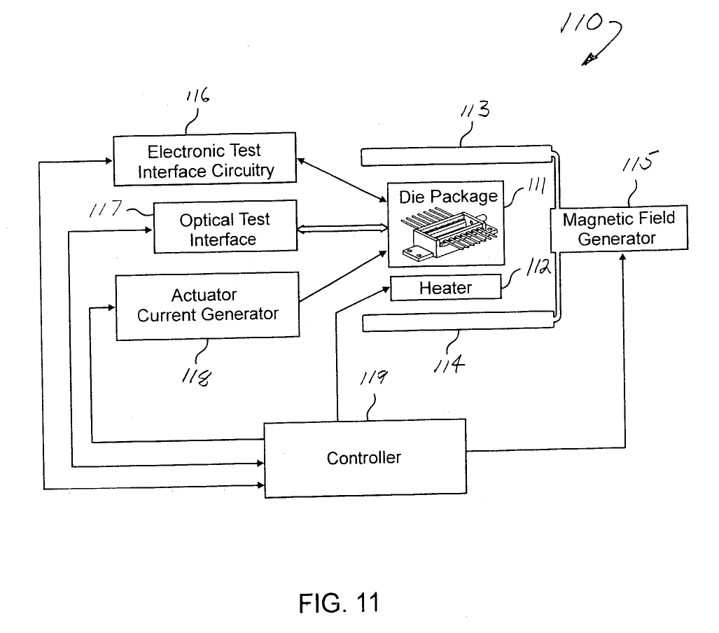

Referring now to FIG. 11, there is shown an operational system 110 for implementing the method described above. The die package 111 is placed upon a heater 112 and within the plates 113,114 of a magnetic field generator 115. Communication with the die package occurs electronically through electronic test interface circuitry 116 and optically through an optical test interface 117. A current generator 118 provides current to the actuator wires aboard the package. An electronic system controller 119 conducts the performance of the above system components.

Because solder undergoes some thermal expansion, the positioning of the boat may change as the solder of the pool solidifies. This may be a known quantity which is accounted for in the adjustment routine. Also, for some applications it may be useful to support the fiber optic cable on a second boat which is mounted on a second solder pool connected to the first pool. In this way, the expansion of the solder pool is identical for both support boats.

### EXAMPLE

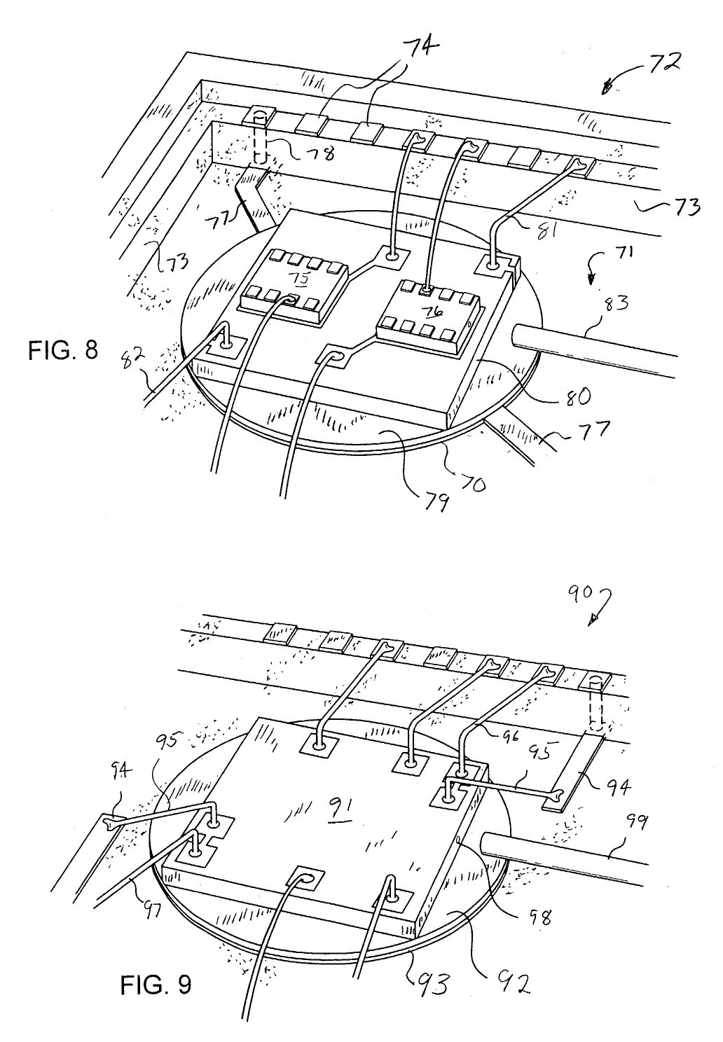

A ceramic package similar in construction to the package shown in FIG. 8 was formed but not sealed. A film of titanium is screen printed onto the floor of the cavity of the package to form a circular pad having a diameter of approximately 0.565 inch and a thickness of between about 0.0002 and 0.0005 inch and drain lines. A 0.0005 inch thick circular preform of eutectic tin-lead or tin-gold-copper solder having a diameter slightly less than the diameter of the pad was placed on top of the pad to form the solder pool.

A substrate or boat was formed having an alumina-type ceramic body having a rectangular top and bottom surface measuring about 0.400 square inch and being about 0.015 inch thick. The bottom surface was metallized with a 0.0001 inch thick layer of titanium. The top surface of the boat had titanium-gold type metallization pads upon which was bonded a logic microcircuit chip and an opto-electronic chip using eutectic gold-tin bond. The top surface also had a pair of diagonally opposite metallization pads for bonding to the actuator wires. Electrical connection between the upper actuator pads and the lower metallized surface was accomplished through a titanium-gold edge connector.

The chip carrying boat was then soldered to the solder preform in position to allow the light source cable to communicate with the opto-electronic chip.

The opto-electronic chip was then wire bonded to the package body. Further, a pair of actuator wires were bonded between the actuator pads on the boat and the package body. The actuator wires were gold wire having a thickness of about 0.002 inch and a length of about 0.250 inch.

The package was mounted on a heatable workholder and electrically connected to test circuitry. Signal loss was measured to be about 2 dB. The heater was heated to about 225 degrees C and a uniform magnetic field of about 1000 Gauss using a magnetic field generator. A current of about 0.5 A was ramped up into each actuator wire which generated a force of about 0.03175 N which translated into a moment of about 2.016×10⁻⁵ Nm. The heat was removed and the package cooled to about 25 degrees C within about 2 seconds, thereby causing the solder pool to solidify. The signal loss was then measured to be about 0.2 dB.

While the preferred embodiments of the invention have been described, modifications can be made and other embodiments may be devised without departing from the spirit of the invention.

What is claimed is:

1. A method for aligning a fiber optic interface in an electro-optical microelectronic package, said method comprises:
causing a current to flow through a wire mechanically linked to a microelectronic die while said wire is subjected to a magnetic field;
thereby moving said die with respect to said field.

2. The method of claim 1, wherein said aligning further comprises:
mounting said die on a pool of reflowable material; and
liquidizing said pool prior to said applying a current.

3. The method of claim 1, wherein said aligning further comprises:
operating said die during said applying a current;
thereby deriving a transmission response measurement.

4. The method of claim 3, wherein said aligning further comprises:
varying an intensity of said current to minimize said transmission response measurement.

5. The method of claim 1, wherein said aligning further comprises:
said reflowable material being electrically conductive; and
draining said current through said reflowable material.

6. The method of claim 1, wherein said wire is made from wire bonded to said die.

10. An electro-optical microelectronic package comprises:
a substrate for carrying an opto-electronic microcircuit die, said substrate being mounted upon a pool of reflowable material; and
an electrically conductive first mechanical actuator wire mechanically contacting said substrate;
whereby said substrate is movable by said first actuator wire when said pool is liquefied, and said first actuator wire is placed within a magnetic field, and an electric current is run through said first actuator wire.

11. The package of claim 10, wherein said pool is formed within a substantially circular tank.

12. The package of claim 10, wherein said pool is formed by a substantially circular solder pad.

13. The package of claim 10, wherein said current drains through said pool.

14. The package of claim 10, wherein said substrate and said pool are shaped and dimensioned to restrict translational movement and allow rotational movement between said substrate and said pool.

15. A method for precisely locating a microelectronic chip upon a surface, said method comprises:
bonding said chip to said surface using an amount of solder, wherein said solder amount is shaped and dimensioned to provide surface tension forces to cause centering of a position of said chip upon said amount while said solder amount is reflowed; and,
reflowing said solder amount.

16. A method for moving a microelectronic circuit chip in relation to a package portion to which it is mounted, said method comprises:
generating a wire bond between a length of wire and said chip; and
moving said length of wire.
